(19) United States
(12) Patent Application Publication
(10) Pub. No.: US 2004/0031620 A1
(43) Pub. Date: Feb. 19, 2004

(54) Corona-resistant wire

(76) Inventors: Klaus Lerchenmueller, Immenstadt (DE); Wolfgang Endres, Remshalden (DE); Cornelius Gaida, Korb (DE)

Correspondence Address: KENYON & KENYON, ONE BROADWAY, NEW YORK, NY, 10004, US

(21) Appl. No.: 10/442,040

(22) Filed: May 20, 2003

(30) Foreign Application Priority Data
May 25, 2002 (DE) 10223354.3

(51) Int. Cl. H01B 7/00

(52) U.S. Cl. 174/120 R

(57) ABSTRACT

A corona-resistant wire for electric windings in particular, the wire having enamel as the primary insulation and having a diameter of 20 μm to 80 μm.

### BACKGROUND INFORMATION

Discharge phenomena may occur when a high electric voltage is applied to electric conductors having inadequate insulation. This is called a partial discharge or corona and may also result in destruction of the insulation layer surrounding the conductor, but it should be suppressed by using a suitable insulator with electric components which are often exposed to high voltages.

U.S. Pat. No. 4,546,041 describes a corona-resistant wire insulated with an enamel containing a polymer and extremely finely divided aluminum oxide. Several layers of enamel are applied to the wire to be insulated. Each layer has a diameter of more than 70 μm, so the resulting wire has a relatively large total cross section.

An object of the present invention is to provide a corona-resistant wire which will make it possible to manufacture small windings.

### SUMMARY OF THE INVENTION

The object on which the present invention is based is achieved according to the present invention by providing a corona-resistant wire having an enamel as the primary insulation and a diameter of 20 to 80 micrometers. Using very thin wires ensures adequate miniaturization of electric windings produced from these wires in an advantageous manner. If the primary insulation is an enamel, it is possible to achieve very thin insulation layers which nevertheless have a high efficacy.

The enamel used as the primary insulation preferably has a polar component in the form of nanoparticles. In another advantageous embodiment, the cavities between the wires of a resulting winding are filled with a secondary insulation in the form of a casting compound or an impregnating resin.

In an especially advantageous embodiment, at least two enamel layers having different compositions are provided as primary insulation on the wire to be insulated.

### BRIEF DESCRIPTION OF THE DRAWINGS

FIG. 1 shows a detail drawing of an ignition coil having an electric winding of a corona-resistant wire like that on which the present invention is based.

FIG. 2 shows a schematic cross section through a wire according to a first exemplary embodiment.

FIG. 3 shows a schematic cross section through a wire according to a second exemplary embodiment.

### DETAILED DESCRIPTION

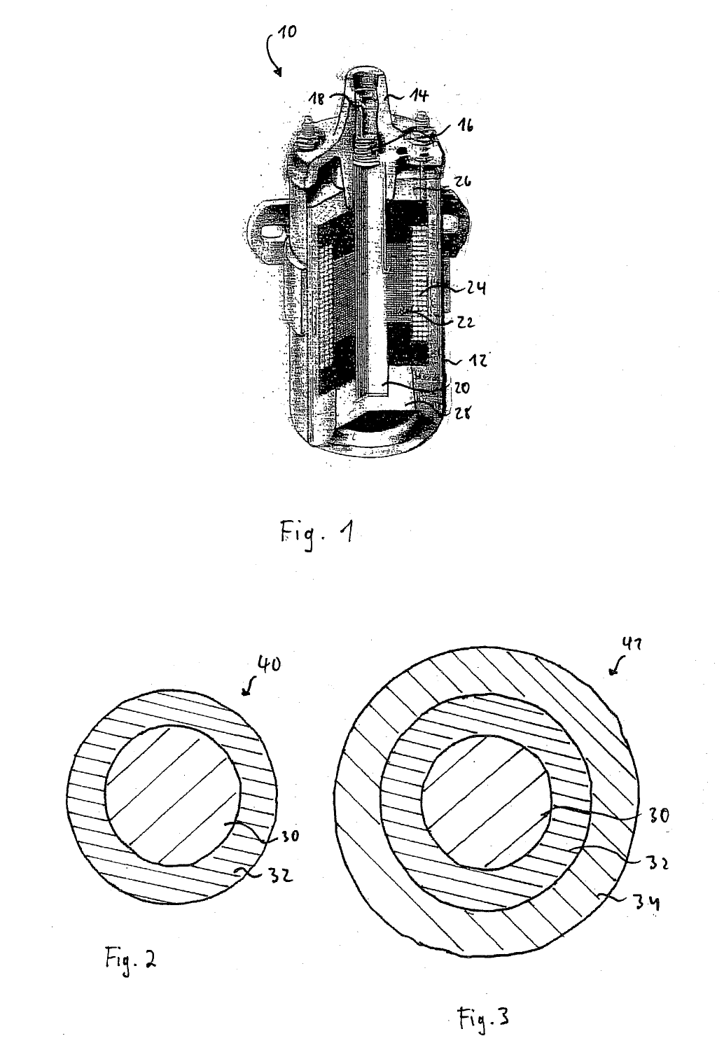

FIG. 1 shows a rod-shaped ignition coil 10 having a housing 12 and a cover 14 plus a high-voltage terminal 16 connected to a sleeve 18. At its center, ignition coil 10 has an iron core 20 surrounded by a high-voltage winding 22, which is in turn enclosed by a low-voltage winding 24. An upper and a lower insulation part 26, 28, respectively, form the upper and lower inner terminations, respectively, of the coil shell. High-voltage winding 22 is preferably made of corona-resistant wires, as shown in FIG. 2 as an example. Wire 40 includes an electrically conducting core 30 and a primary insulation 32. To achieve miniaturization of ignition coil 10, corona-resistant wire 40 has a very small diameter of 20 μm to 80 μm. Primary insulation 32 is formed by an enamel layer containing a polyamideimide or a polyesterimide as an organic binder. In addition, inorganic fillers, preferably having a dipole character, are also provided.

In an especially preferred embodiment, titanium dioxide nanoparticles are used as the filler. The enamel layer of primary insulation 32 may be applied to electrically conducting core 30 in one or more method steps. Due to the choice of a suitable primary insulation 32, wire 40 has a higher corona strength by a factor of 300 to 1000 than conventional winding wires in high-voltage winding 22.

FIG. 3 shows another embodiment of a corona-resistant wire 42. Electrically conducting core 30 here has a first primary insulation in the form of an enamel layer 32 and a primary insulation 34 in the form of a second enamel layer having a different composition. In addition, other enamel layers of the same composition or a different composition may also be provided.

When using corona-resistant wires in electric windings, they preferably also have a secondary insulation (not shown) in the form of a casting (sealing) compound, preferably epoxy resin. The secondary insulation is produced by impregnating electric windings 22, 24 with the casting compound, e.g., during production of an ignition coil.

Other areas of application of electric windings having the corona-resistant wires described here include lighting systems, ac voltage transmitters and converter-supplied engines.

What is claimed is:

1. A corona-resistant wire comprising:
a primary insulation composed of an enamel,
wherein a diameter of the wire is between 20 μm and 80 μm.

2. The wire according to claim 1, wherein the primary insulation has a diameter between 20 μm and 80 μm.

3. The wire according to claim 1, wherein the enamel contains a polar component.

4. The wire according to claim 3, wherein the polar component is composed of nanoparticles.

5. The wire according to claim 3, wherein the polar component includes titanium dioxide.

6. The wire according to claim 1, further comprising an electrically conducting core, the enamel being applied directly to the core.

7. The wire according to claim 1, wherein the primary insulation includes a plurality of enamel layers.

8. The wire according to claim 1, wherein the primary insulation includes an enamel layer, and further comprising at least one additional layer having a different composition than the enamel layer and being applied to the enamel layer.

9. The wire according to claim 8, wherein the at least one additional layer includes an enamel layer.

10. The wire according to claim 1, wherein the wire is part of an electric winding.

11. The wire according to claim 1, wherein the wire is part of an electric winding having a secondary insulation formed by a casting compound.

12. The wire according to claim 1, wherein the wire is part of an ignition coil.

13. The wire according to claim 1, wherein the wire is part of a lighting system.

14. The wire according to claim 1, wherein the wire is part of an a.c. voltage transmitter.

15. The wire according to claim 1, wherein the wire is part of a converter-supplied motor.
